(19) United States
(12) Patent Application Publication
(10) Pub. No.: US 2007/0269281 A1
(43) Pub. Date: Nov. 22, 2007

(54) Drill Bushing

(76) Inventor: Thomas Ostling, Esilstuna (SE)

Correspondence Address: Mark P Stone, 25 Third Street, 4th Floor, Stamford, CT, 06905, US

(21) Appl. No.: 11/663,402

(22) PCT Filed: Oct. 14, 2005
(86) PCT No.: PCT/SE05/01536

§ 371 Date: Mar. 21, 2007

(30) Foreign Application Priority Data
Oct. 22, 2004 (SE) 0402563-1

(51) Int. Cl. B23B 31/10

(52) U.S. Cl. 408/239 A

(57) ABSTRACT

The invention relates to a drill bushing for engagement with a drilling steel, wherein said drill bushing (2) has contact surfaces (4) for contact with a drilling steel (1), said contact surfaces (4) having interior, inwards curved shapes, whereby edge abutment of a drilling steel (1) against said contact surfaces (4) is avoided. By way of the invention, a better wear picture is obtained for the shank of a drilling steel.

### TECHNICAL FIELD OF THE INVENTION

The present invention relates to a drill bushing for engagement with a drilling steel, according to the preamble of claim 1.

### BACKGROUND OF THE INVENTION

In rock drilling the quality and design of the drilling steel is of outmost importance to obtain a good and efficient drilling.

A problem when drilling is the large wear of drilling steels, this even though the present drilling steels withstand high stresses. The drilling steel is of course worn mainly at the drill bit itself, but wear occurs also at the other end, that is on the shank of the drilling steel by wear against a drill sleeve or a drill chuck. The concentrated wear comprises high surface pressures in the contact points and cutting tendencies. The drilling steel and the corresponding sleeve is thus subjected to high stresses and this on a very limited area. This leads to limited and shortened length of life of the drilling steel and also of the drill sleeve. Further, there is also a risk for local melting of the drilling steel, as the drilling steel when it is rotated at the same time as it is subjected to impacts, quickly becomes very warm. This can in some cases lead to operational disturbances and breakdowns, which is very costly.

It would thus be desirable to provide a solution, by which the length of life of the drilling steel and also the drill bushing may be substantially extended.

### The Objects and the Most Important Characteristics of the Invention

It is an object of the present invention to provide a drill bushing which solves, or at least reduces, the above problems. More specifically, it is an object of the present invention to provide an improved design of a drill bushing, whereby the drilling steel as well as the bushing are subjected to a lower stress and a lesser wear, whereby these thereby obtain an increased length of life.

These and other objects are reached according to the present invention by a drill bushing, as defined in the characterising portion of claim 1.

According to the present invention the above mentioned objects are reached by a drill bushing with contact surfaces which have internal, inwards curved shapes. By the invention an improved grip is provided between sleeve and drilling steel, which gives longer length of life for these components and thereby a more economical drilling. High surface pressures in the areas of the edges of the drilling steel shank are avoided effectively with reduced stress as a result.

In a preferred embodiment of the invention the contact surfaces of the drill bushing are continuously curved, whereby an even, symmetrical drill bushing is obtained.

In a preferred embodiment of the invention the contact surfaces are convex surfaces with the same radius of curvature. Alternatively the contact surfaces may be elliptical, parabolic or have another continuously curved shape. Thereby a flexible solution is obtained, with contact surfaces that can be adapted to a specific application.

In a preferred embodiment of the invention the contact surfaces of the drill bushing, which are in engagement with a drilling steel, together have an optional shape, as for example hexagonal, heptagonal or octagonal main shape. Thereby a drill bushing is provided, the profile of which may be varied in a simple manner according to need during preservation of the properties obtained through the invention.

According to another preferred embodiment each and every one of the corners of the drill bushing are designed with enough space to prevent that a respective corner of a drilling steel comes into contact with the drill bushing. Thereby detrimental contact influence on the corners of the drilling steel is avoided, whereby cutting tendencies may be avoided with further certainty.

According to another preferred embodiment, the connection points of the contact surfaces to each other form corners with convex rounded shape, pointed shape or concave shape. Thereby further freedom of design and a flexible solution is obtained.

Further characteristics and advantages of the present invention will be evident from the following detailed description.

### BRIEF DESCRIPTION OF THE DRAWINGS

FIG. 1 shows schematically drilling steel, drill bushing and drill shank in a typical assembly.

FIG. 2 shows an earlier known form of drilling steel and sleeve.

FIG. 3 shows a first embodiment of the present invention.

FIG. 4 shows a second embodiment of the present invention.

### DETAILED DESCRIPTION

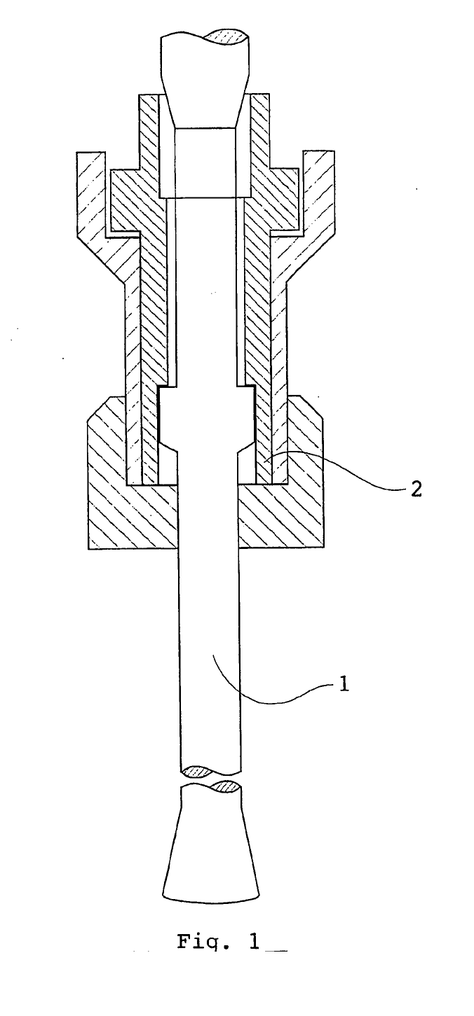

FIG. 1 shows schematically, and for the purpose of facilitating the understanding of the present invention, a drilling steel 1 and a drill bushing 2. The present invention is related to the grip between the drill bushing 2 and the drilling steel 1.

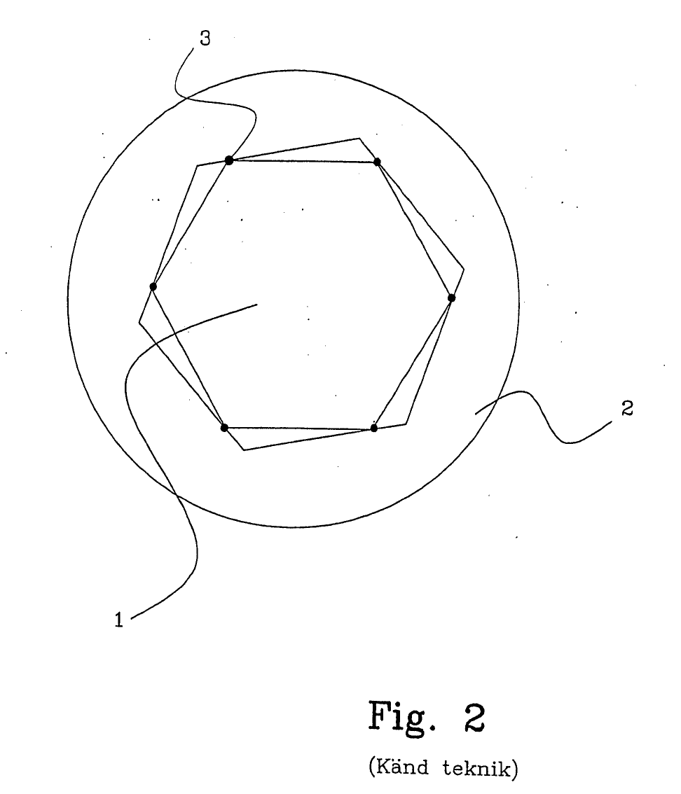

As has been described above a wear occurs on the shank of a drilling steel, apart from the wear of the drill bit itself, and the present invention has in view to decrease this wear. FIG. 2 shows known technology, with a drilling steel 1 contained in a drill sleeve, or a drill bushing 2. In FIG. 2 the drilling steel and the drill bushing are shown without tolerances in order to illustrate the edge abutment, but it is realized that a certain space is required between the drilling steel 1 and the drill bushing 2. When drilling, the drilling steel 1 strikes against the rock for advancement, and at a rotation at the same time as the drilling steel is subjected to a blow, a very concentrated wear arises on the shank of the drilling steel 1, especially at the point indicated with 3 and the corresponding points around the entire drilling steel, in FIG. 2. In order to facilitate mounting of the drilling steel in the drill bushing 2 some tolerances are required as mentioned, wherefore this undesired edge abutment unavoidably arises at the operation of a device according to the known technology. The corners of the drilling steel 1 are thereby heated up, and at normal frequency of drilling the drilling steel quickly becomes warm and in some cases even local melting can occur. With this technology it is thus the outmost edges of the drilling steel that are worn, and the wear takes place in other words on a very limited surface. The concentrated wear gives high surface pressures in the contact points and also cutting tendencies and thus high stresses. This results in deformation of the drilling steel and a limited length of life of the drilling steel and in some cases also breakdowns.

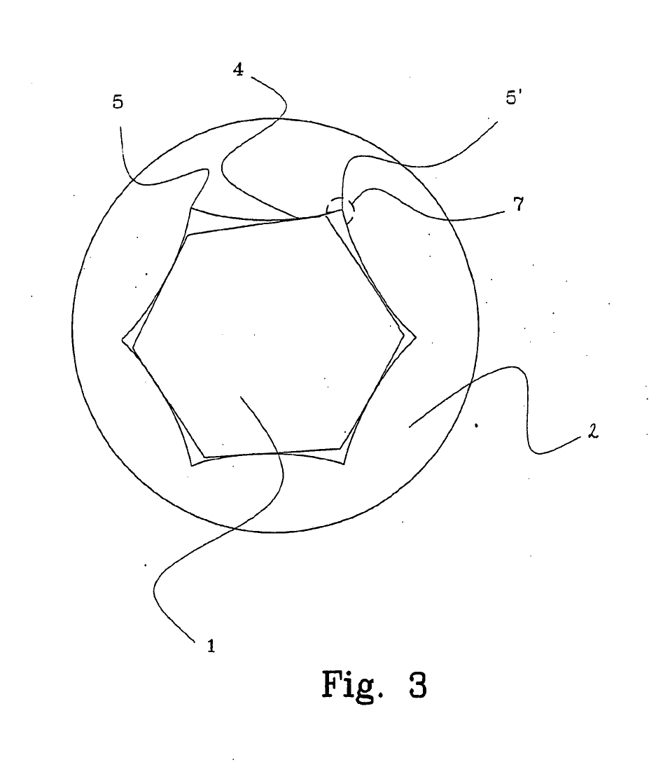

FIG. 3 shows a drill bushing according to the present invention. As in the previous figure the drill bushing 2 and the drilling steel 1 are shown without any tolerances, but it is realized that a certain space is required between the drill bushing 2 and the shank of the drilling steel to accommodate tolerances on the shank of the drilling steel. The contact surfaces 4 to the drill bushing 2 define in one embodiment a closed main shape and preferably have internal, inwards continuously curved shapes. Preferably the contact surfaces 4 are slightly curved, or convex, which gives larger contact surfaces against the drilling steel 1 and thereby distributes the wear on a larger surface. The radius of curvature for the contact surfaces 4 may be chosen according to need and does not have to be equally large for each contact surface 4, but is preferably the same for all of the contact surfaces 4. A radius of curvature which gives a circular shape is a preferred embodiment, but also an elliptical, parabolic or other continuously curved shape on the contact surface is conceivable. By means of that the inner walls of the drill bushing 2 or the sleeve, that is their contact surfaces 4, are slightly curved, a much more favourable wear picture is thus obtained on the shank of the drilling steel 1 in comparison with the known technology. Instead of that the outmost edges of the hexagonal drill bushing 2 are worn, a wear is obtained on a larger surface 4 a distance in from the corner. As the contact surfaces 4 for the drill bushing 2 according to the present invention are larger and get better bearing capacity, the surface pressure is reduced and the above mentioned problems with the known technology are considerably decreased. According to the invention, moreover, possible wear results in a further increased contact surface as the contact surface of the drilling steel 1 (or the drill bushing 2) would be somewhat worn down.

All the corners of the drill bushing 2, exemplified by 5, 5′, are preferably adapted with enough space so that the corners of the drilling steel 1 will not come into contact with the respective corners 5, 5′ of the drill bushing 2. Thereby the problems with burns and cutting tendencies that exist with the known technology, and which are accounted for above, are further reduced. In the embodiment in FIG. 3 the corners of the contact surfaces are shown to be pointedly connected, which is only a conceivable shape. The corners may alternatively be rounded, or designed with an extra large space, as is exemplified in one of the corners 5′ with the dotted line 7. Also other embodiments of the different contact surface 4 connection points to each other are conceivable.

It especially applies that only those parts of the inner surfaces of the drill bushing 2, which make contact with the drilling steel 1 during the drilling, shall show continuously curved shapes. Other parts of the inner surfaces may be flat or have another shape. Through the whole description contact surfaces 4 refer to the part of the inner surfaces of the drill bushing 2, which make contact with the drilling steel 1 during drilling.

The embodiment of the invention which is shown in the figures comprises a hexagonal main shape on both drilling steel and sleeve. As is realized by a person skilled in the art, of course even other shapes, that is another number of sides than six, on drilling steel 1 and thereby also on the drill bushing 2, may be used. The drill bushing 2 may for example have a heptagonal shape, an octagonal shape etc., or fewer sides than six.

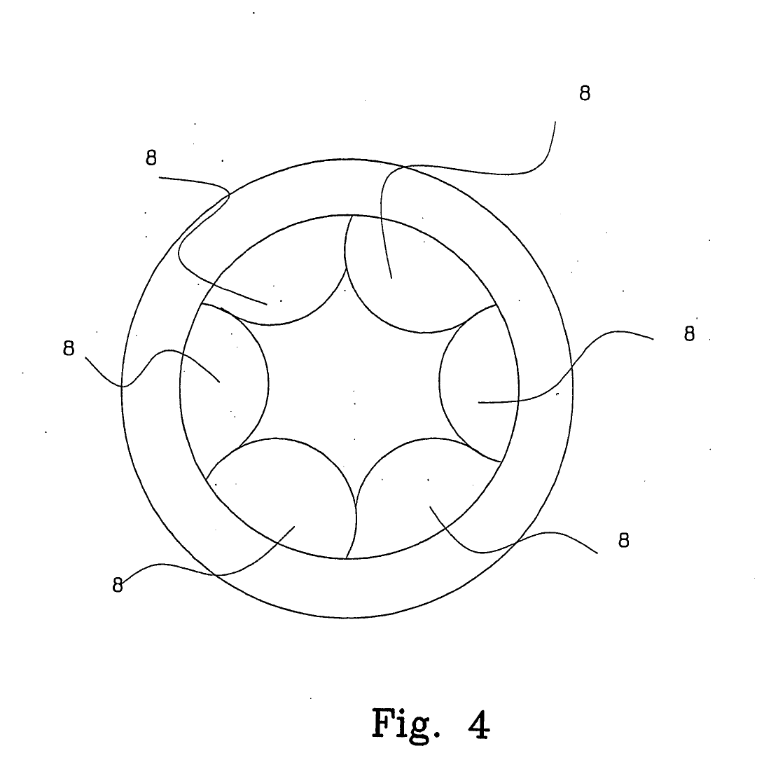

In the description a closed main shape has been shown. It is of course also possible to design the drill bushing 2 in separate parts. In an alternative embodiment of the invention the drill bushing 2 may thus be made in separate parts 8, and FIG. 4 shows schematically one example of this. The separate parts 8 are in this example mounted in a ring. Other variants may for example comprise gaps between the separate parts 8 (not shown). To make the drill bushing in separate parts 8 may give a simplified manufacture.

It is of course also possible to choose materials, which have higher resistance against wear, which gives further cost savings.

1. Drill bushing for engagement with a drilling steel, characterized in, that said drill bushing (2) has contact surfaces (4) for contact with a drilling steel (1), said contact surfaces (4) having interior, inwards curved shapes, whereby edge abutment of a drilling steel (1) against said contact surfaces (4) is avoided.

2. Drill bushing according to claim 1, wherein said contact surfaces (4) have interior, inwards continuously curved shapes.

3. Drill bushing according to claim 1, wherein the contact surfaces (4) are convex, circular surfaces with equally large radiuses of curvature.

4. Drill bushing according to claim 1, wherein the contact surfaces (4) have elliptical, parabolic or other curved shape.

5. Drill bushing according to claim 1, wherein the contact surfaces (4) of the drill bushing (2) together have a triangular, quadrangular, pentagonal, hexagonal, heptagonal, or octagonal main shape.

6. Drill bushing according to claim 3, wherein each and every one of the corners of the drill bushing (2) are designed with enough space to prevent that the respective corners of a drilling steel (1) come into contact with said drill bushing (2).

7. Drill bushing according to claim 1, wherein the connection points of the contact surfaces (4) to each other form a corner with convex rounded shape, pointed shape or a concave shape.

8. Drill bushing according to claim 2, wherein the contact surfaces (4) are convex, circular surfaces with equally large radiuses of curvature.

9. Drill bushing according to claim 2, wherein the contact surfaces (4) have elliptical, parabolic or other curved shape.

10. Drill bushing according to claim 2, wherein the contact surfaces (4) of the drill bushing (2) together have a triangular, quadrangular, pentagonal, hexagonal, heptagonal, or octagonal main shape.

11. Drill bushing according to claim 3, wherein the contact surfaces (4) of the drill bushing (2) together have a triangular, quadrangular, pentagonal, hexagonal, heptagonal, or octagonal main shape.

12. Drill bushing according to claim 4, wherein the contact surfaces (4) of the drill bushing (2) together have a triangular, quadrangular, pentagonal, hexagonal, heptagonal, or octagonal main shape.

13. Drill bushing according to claim 8, wherein the contact surfaces (4) of the drill bushing (2) together have a triangular, quadrangular, pentagonal, hexagonal, heptagonal, or octagonal main shape.

14. Drill bushing according to claim 9, wherein the contact surfaces (4) of the drill bushing (2) together have a triangular, quadrangular, pentagonal, hexagonal, heptagonal, or octagonal main shape.

15. Drill bushing according to claim 4, wherein each and every one of the corners of the drill bushing (2) are designed with enough space to prevent that the respective corners of a drilling steel (1) come into contact with said drill bushing (2).

16. Drill bushing according to claim 8, wherein each and every one of the corners of the drill bushing (2) are designed with enough space to prevent that the respective corners of a drilling steel (1) come into contact with said drill bushing (2).

17. Drill bushing according to claim 9, wherein each and every one of the corners of the drill bushing (2) are designed with enough space to prevent that the respective corners of a drilling steel (1) come into contact with said drill bushing (2).

18. Drill bushing according to claim 2, wherein the connection points of the contact surfaces (4) to each other form a corner with convex rounded shape, pointed shape or a concave shape.

19. Drill bushing according to claim 3, wherein the connection points of the contact surfaces (4) to each other form a corner with convex rounded shape, pointed shape or a concave shape.

20. Drill bushing according to claim 4, wherein the connection points of the contact surfaces (4) to each other form a corner with convex rounded shape, pointed shape or a concave shape.
